(19) United States
(12) Patent Application Publication
(10) Pub. No.: US 2020/0040470 A1
(43) Pub. Date: Feb. 6, 2020

(54) ARTIFICIAL PHOTOSYNTHESIS MODULE ELECTRODE AND ARTIFICIAL PHOTOSYNTHESIS MODULE

(71) Applicants: FUJIFILM Corporation, Tokyo (JP); JAPAN TECHNOLOGICAL RESEARCH ASSOCIATION OF ARTIFICIAL PHOTOSYNTHETIC CHEMICAL PROCESS, Tokyo (JP)

(72) Inventors: Yoshihiro Aburaya, Kanagawa (JP); Satoshi Yoshida, Kanagawa (JP)

(73) Assignees: FUJIFILM Corporation, Tokyo (JP); JAPAN TECHNOLOGICAL RESEARCH ASSOCIATION OF ARTIFICIAL PHOTOSYNTHETIC CHEMICAL PROCESS, Tokyo (JP)

(21) Appl. No.: 16/594,770

(22) Filed: Oct. 7, 2019

Related U.S. Application Data
(63) Continuation of application No. PCT/JP2018/015739, filed on Apr. 16, 2018.

(30) Foreign Application Priority Data
Apr. 28, 2017 (JP) 2017-089985
Jul. 6, 2017 (JP) 2017-132952

(51) Int. Cl. C25B 11/02; C25B 1/04; C25B 1/00; C25B 9/06; C01B 3/04; C01B 13/02

(52) U.S. Cl. CPC C25B 11/02; C25B 1/04; C01B 13/0207; C25B 9/06; C01B 3/042; C25B 1/003

(57) ABSTRACT

Provided are an artificial photosynthesis module electrode with high efficiency and an artificial photosynthesis module having the artificial photosynthesis module electrode.

The artificial photosynthesis module electrode has a first electrode that decomposes a raw material fluid with light to obtain a first fluid, a first conductive member connected to the first electrode, a second electrode that decomposes the raw material fluid with light to obtain the second fluid, and a second conductive member connected to the second electrode. The first electrode has a plurality of first electrode parts connected to the first conductive member and disposed with a gap in a first direction on a first plane. The second electrode has a plurality of second electrode parts connected to the second conductive member and disposed with a gap in the first direction on a second plane parallel to or identical to the first plane. The first electrode part and the second electrode part are alternately disposed with each other as seen from a second direction perpendicular to the first plane. An electrode spacing between the first electrode part and the second electrode part is more than 5 μm and less than 1 mm.

### CROSS-REFERENCE TO RELATED APPLICATIONS

This application is a Continuation of PCT International Application No. PCT/JP2018/015739 filed on Apr. 16, 2018, which claims priority under 35 U.S.C. § 119(a) to Japanese Patent Application No. 2017-089985 filed on Apr. 28, 2017 and Japanese Patent Application No. 2017-132952 filed on Jul. 6, 2017. The above application is hereby expressly incorporated by reference, in its entirety, into the present application.

### BACKGROUND OF THE INVENTION

### 1. Field of the Invention

The present invention relates to an artificial photosynthesis module electrode that decomposes a raw material fluid utilizing light energy to obtain a substance different from the raw material fluid, and an artificial photosynthesis module having the artificial photosynthesis module electrode, and particularly to an artificial photosynthesis module electrode and an artificial photosynthesis module in which an electrode spacing between a first electrode that decomposes a raw material fluid with light to obtain a first fluid and a second electrode that decomposes the raw material fluid with the light to obtain a second fluid is specified.

### 2. Description of the Related Art

Nowadays, water is decomposed using a photocatalyst and utilizing solar light energy, which is renewable energy, to obtain gases, such as hydrogen gas and oxygen gas.

For example, JP2012-188683A discloses a gas generation apparatus that generates oxygen gas and hydrogen gas from an electrolytic solution including water. The gas generation apparatus of JP2012-188683A includes an anode electrode that generates the oxygen gas from the electrolytic solution, a cathode electrode that generates the hydrogen gas from hydrogen ions and electrons generated with the electrolytic solution, a photocatalyst-containing layer that is provided in at least one of the anode electrode and the cathode electrode and includes a first photocatalyst that generates the oxygen gas from the electrolytic solution by a photocatalytic reaction utilizing visible light, and a second photocatalyst that generates the hydrogen gas by the photocatalytic reaction, a plurality of through-holes that are provided in at least one of the anode electrode or the cathode electrode, do not allow the electrolytic solution to pass therethrough, and allow the generated oxygen gas or hydrogen gas to pass therethrough, and a gas storage part that stores the oxygen gas or hydrogen gas that has passed through the through-holes.

### SUMMARY OF THE INVENTION

As described above, JP2012-188683A has the plurality of through-holes that allow the generated oxygen gas or hydrogen gas to pass therethrough, is poor in the durability of a support substrate, is poor in the utilization efficiency of an electrode, and is poor also in the efficiency at which the oxygen gas and the hydrogen gas are generated.

Additionally, in JP2012-188683A a ring-shaped photocatalyst-containing layer is provided at a peripheral edge of a through-hole, and the distance between the through-holes is 0.1 μm or more. In such a configuration, in a case where the oxygen gas and the hydrogen gas are continuously generated, it is confirmed that salting-out or the like occurs and gas generation efficiency decreases.

An object of the invention is to solve the problems based on the aforementioned related art and provide an artificial photosynthesis module electrode and an artificial photosynthesis module with high efficiency.

In order to achieve the above-described object, the invention provides an artificial photosynthesis module electrode comprising a first electrode that decomposes a raw material fluid with light to obtain a first fluid; a first conductive member connected to the first electrode; a second electrode that decomposes the raw material fluid with the light to obtain a second fluid; and a second conductive member connected to the second electrode. The first electrode has a plurality of first electrode parts connected to the first conductive member and disposed with a gap in a first direction on a first plane. The second electrode has a plurality of second electrode parts connected to the second conductive member and disposed with a gap in the first direction on a second plane parallel to or identical to the first plane. The first electrode part and the second electrode part are alternately disposed with each other as seen from a second direction perpendicular to the first plane. An electrode spacing between the first electrode part and the second electrode part is more than 5 μm and less than 1 mm.

Additionally, the invention is an artificial photosynthesis module electrode comprising a first electrode that decomposes a raw material fluid with light to obtain a first fluid; a first electrode base material part connected to the first electrode; a second electrode that decomposes the raw material fluid with the light to obtain a second fluid; and a second electrode base material part connected to the second electrode. The first electrode has a plurality of first electrode parts connected to the first electrode base material part and disposed with a gap in a first direction on a first plane, and the first electrode includes a first recess formed by the first electrode parts and the first electrode base material part. The second electrode has a plurality of second electrode parts connected to the second electrode base material part and disposed with a gap in the first direction on a second plane parallel to or identical to the first plane, and the second electrode includes a second recess formed by the second electrode parts and the second electrode base material part. The first electrode part and the second electrode part are alternately disposed with each other as seen from a second direction perpendicular to the first plane, the second electrode part enters the first recess, and the first electrode part enters the second recess. An electrode spacing between the first electrode part and the second electrode part is more than 5 μm and less than 1 mm. The electrode spacing is an average value of a spacing between the first electrode part and the second electrode base material part, a spacing between the second electrode part and the first electrode base material part, and a distance between the first electrode part and the second electrode part that are adjacent to each other.

It is preferable that the electrode spacing is more than 5 μm and 500 μm or less, it is more preferable that the electrode spacing is 10 μm or more and 500 μm or less, it is still more preferable that the electrode spacing is 20 μm or more and 500 μm or less, and it is even more preferable that the electrode spacing is 10 μm or more and 200 μM or less.

For example, the first plane and the second plane are on the same plane, and the electrode spacing is a distance in the first direction between the first electrode part and the second electrode part that are adjacent to each other.

For example, the first plane and the second plane are spaced apart from each other in the second direction, the first electrode part and the second electrode part are disposed to be spaced apart from each other in the first direction, and with a direction perpendicular to both the first direction and the second direction being a third direction, the electrode spacing is a distance between the first electrode part and the second electrode part adjacent to each other in a cross-section perpendicular to the third direction.

For example, the first plane and the second plane are spaced apart from each other in the second direction, the first electrode part and the second electrode part are disposed such that at least portions thereof overlap each other in the first direction, and the electrode spacing is a distance between the first electrode part and the second electrode part in the second direction.

It is preferable that the first electrode part or the second electrode part, which is disposed on an incidence side of the light, out of the first electrode part and the second electrode part, transmits the light.

It is preferable that the first electrode includes a first recess formed by the first electrode parts and the first conductive member, or the second electrode includes electrode a second recess formed by the second electrode parts and the second conductive member, and the electrode part on the other side enters the first recess or the second recess as seen from the second direction.

It is preferable that the first electrode includes a first recess formed by the first electrode parts and the first conductive member, the second electrode includes a second recess formed by the second electrode parts and the second conductive member, as seen from the second direction, the second electrode part enters the first recess and the first electrode part enters the second recess, the electrode spacing is an average value of a spacing between the first electrode part and the second conductive member, a spacing between the second electrode part and the first conductive member, and a distance between the first electrode part and the second electrode part that are adjacent to each other.

It is preferable that when a direction perpendicular to both the first direction and the second direction is defined as a third direction, cross-sections of the first electrode part of the first electrode and the second electrode part of the second electrode perpendicular to the third direction have a rectangular shape, a triangular shape, a convex type, a semicircular shape, or a round shape.

It is preferable that the first electrode has a first substrate, a first conductive layer provided on the first substrate, a first photocatalyst layer provided on the first conductive layer, and a first co-catalyst that is carried and supported on at least a portion of the first photocatalyst layer, the second electrode has a second substrate, a second conductive layer provided on the second substrate, a second photocatalyst layer provided on the second conductive layer, and a second co-catalyst that is carried and supported on at least a portion of the second photocatalyst layer.

It is preferable that at least one of the first electrode or the second electrode has a pn junction.

It is preferable that the raw material fluid is an electrolytic solution having an electrical conductivity of 200 mS/cm or less.

It is preferable to further comprise a space of 10 μm or more different from the electrode spacing.

It is preferable that one or more and less than fifty pairs of the first electrode parts and the second electrode parts are included per 1 mm in length in the first direction.

It is preferable that the first fluid is a gas or a liquid, and the second fluid is a gas or a liquid.

It is preferable that the raw material fluid is water, the first fluid is oxygen, and the second fluid is hydrogen.

Additionally, an artificial photosynthesis module comprising the above-described artificial photosynthesis module electrode is provided.

According to the invention, the artificial photosynthesis module electrode and the artificial photosynthesis module with high efficiency can be obtained.

### BRIEF DESCRIPTION OF THE DRAWINGS

FIG. 1 is a schematic cross-sectional view illustrating a first example of an artificial photosynthesis module of an embodiment of the invention.

FIG. 2 is a schematic plan view illustrating a first example of an electrode arrangement configuration of the artificial photosynthesis module of the embodiment of the invention.

FIG. 3 is a schematic cross-sectional view illustrating a second example of the electrode arrangement configuration of the artificial photosynthesis module of the embodiment of the invention.

FIG. 4 is a schematic plan view illustrating the second example of the electrode arrangement configuration of the artificial photosynthesis module of the embodiment of the invention.

FIG. 5 is a schematic plan view illustrating a modification example of the electrode arrangement configuration of the artificial photosynthesis module of the embodiment of the invention.

FIG. 6 is a schematic cross-sectional view illustrating a third example of the electrode arrangement configuration of the artificial photosynthesis module of the embodiment of the invention.

FIG. 7 is a schematic plan view illustrating the third example of the electrode arrangement configuration of the artificial photosynthesis module of the embodiment of the invention.

FIG. 8 is a schematic cross-sectional view illustrating an example of an electrode structure of the artificial photosynthesis module of the embodiment of the invention.

FIG. 9 is a schematic perspective view illustrating a first example of an electrode configuration of the artificial photosynthesis module of the embodiment of the invention.

FIG. 10 is a schematic perspective view illustrating a second example of the electrode configuration of the artificial photosynthesis module of the embodiment of the invention.

FIG. 11 is a schematic perspective view illustrating a third example of the electrode configuration of the artificial photosynthesis module of the embodiment of the invention.

FIG. 12 is a schematic perspective view illustrating a fourth example of the electrode configuration of the artificial photosynthesis module of the embodiment of the invention.

### DESCRIPTION OF THE PREFERRED EMBODIMENTS

Hereinafter, an artificial photosynthesis module electrode and an artificial photosynthesis module of the invention will be described in detail with reference to preferred embodiments illustrated in the attached drawings.

In addition, the drawings illustrated below are merely examples for describing the invention, and the invention is not limited to the drawings illustrated below.

In addition, in the following, “to” showing a numerical range includes numerical values described on both sides thereof. For example, s being a numerical value α to a numerical value β means that the range of c is a range including the numerical value α and the numerical value β, and in a case where these are expressed by mathematical symbols, α≤ε≤β is satisfied.

Angles, such as “an angle expressed by a specific numerical value”, “parallel”, “perpendicular”, and “orthogonal” include error ranges generally allowed in the technical field unless otherwise specified.

The “same”, “all”, and the like include error ranges generally allowed in the corresponding technical field.

Unless otherwise stated, the term “transparent” means that the light transmittance is at least 60% or more in a region having a wavelength of 380 nm to 780 nm, 80% or more preferably, more preferably 85% or more, even more preferably 90% or more.

The light transmittance is measured using “Method of testing transmittance, reflectivity, emissivity, and solar heat gain coefficient of sheet glass” defined in Japanese Industrial Standard (JIS) R 3106-1998.

The artificial photosynthesis module electrode of the invention is an electrode that decomposes a raw material fluid serving as a decomposition target by utilizing light energy to obtain substance separate from the raw material fluid, and an electrode that decomposes the raw material fluid with light to obtain a first fluid and a second fluid.

The artificial photosynthesis module electrode has a first electrode that decomposes the raw material fluid with light to obtain the first fluid, a first conductive member connected to the first electrode, a second electrode that decomposes the raw material fluid with light to obtain the second fluid, and a second conductive member connected to the second electrode.

The artificial photosynthesis module is a device having the above-described artificial photosynthesis module electrode, and decomposes the raw material fluid utilizing the light energy to obtain the separate substance.

In addition, the first fluid and the second fluid are not particularly limited as long as the first and second fluids are fluids, respectively, and are gas or liquid. In addition, the above-described separate substance is a substance that can be obtained by oxidizing or reducing the raw material fluid.

Hereinafter, the artificial photosynthesis module electrode and the artificial photosynthesis module will be described.

A first example of the artificial photosynthesis module will be described taking a case where the raw material fluid is water, the first fluid is oxygen, and the second fluid is hydrogen as an example.

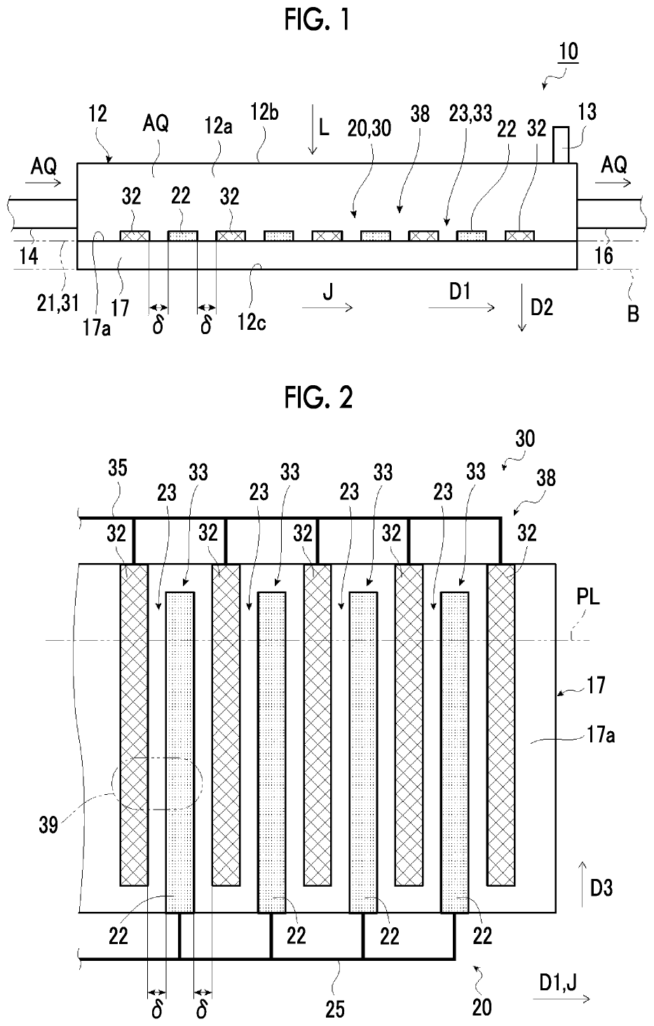

FIG. 1 is a schematic cross-sectional view illustrating the first example of the artificial photosynthesis module of the embodiment of the invention, and FIG. 2 is a schematic plan view illustrating a first example of an electrode arrangement configuration of the artificial photosynthesis module of the embodiment of the invention. FIG. 1 illustrates a cross-section PL perpendicular to a third direction D3 of FIG. 2.

The artificial photosynthesis module 10 illustrated in FIG. 1 has an oxygen generation electrode 20 that is an example of the first electrode capable of, for example, decomposing water AQ, which is the raw material fluid, with light L to generate oxygen, which is the first fluid, as the gas, and a hydrogen generation electrode 30 that is an example of the second electrode capable of, for example, decomposing the water AQ with the light L to generate hydrogen, which is the second fluid, as the gas. An artificial photosynthesis module electrode 38 to be used for the artificial photosynthesis module 10 is constituted by the oxygen generation electrode 20 and the hydrogen generation electrode 30.

The artificial photosynthesis module 10 has a container 12. The container 12 is disposed, for example, on a horizontal plane B.

A lateral surface 12d of the container 12 is provided with a supply pipe 14 for supplying the water AQ to an inside 12a of the container 12. A lateral surface 12e, which faces the lateral surface 12d in a direction J, is provided with a discharge pipe 16 for discharging the water AQ of the inside 12a of the container 12 to the outside. In the artificial photosynthesis module 10, a direction in which the water AQ flows is the direction J.

The container 12 is provided with an exhaust pipe 13. The exhaust pipe 13 is for taking out the oxygen and the hydrogen, which have been generated in the inside 12a of the container 12, to the outside of the container 12.

The discharge pipe 16 also has a role of taking out the water AQ including the oxygen generated in the oxygen generation electrode 20 and the hydrogen generated in the hydrogen generation electrode 30 to the outside of the container 12. The oxygen generated in the oxygen generation electrode 20 and the hydrogen generated in the hydrogen generation electrode 30 may be recovered from the drained water AQ. A configuration in which a recovery unit (not illustrated) that recovers the oxygen and the hydrogen is connected to at least the exhaust pipe 13 out of the exhaust pipe 13 and the discharge pipe 16 may be adopted.

Additionally, in the artificial photosynthesis module 10, a configuration having a supply unit (not illustrated) that supplies the water AQ, which has passed through the recovery unit, again to the inside 12a of the container 12 via the supply pipe 14, may be adopted in addition to the recovery unit (not illustrated). In this case, in the artificial photosynthesis module 10, the water AQ is circulated and used.

The oxygen generation electrode 20 has a plurality of flat plate-shaped oxygen electrode parts 22 that are disposed with a gap 23 in a first direction D1 on a first plane 21. As illustrated in FIG. 2, the plurality of flat plate-shaped oxygen electrode parts 22 have an oblong shape in the plan view, respectively, and the oxygen electrode parts 22 are disposed with the gap 23 in the first direction D1 with long sides being aligned in parallel. Additionally, the oxygen electrode parts 22 are electrically connected to each other by a first conductive member 25.

The cross-sectional shape of each oxygen electrode part 22 in the cross-section PL perpendicular to the third direction D3 is a rectangular shape. An oblong shape and a square are included in the rectangular shape. The oxygen electrode part 22 is a first electrode part.

The hydrogen generation electrode 30 has a plurality of flat plate-shaped hydrogen electrode parts 32 that are disposed with a gap 33 in the first direction D1 on a second plane 31. As illustrated in FIG. 2, the plurality of flat plate-shaped hydrogen electrode parts 32 have an oblong shape in the plan view, respectively, the hydrogen electrode parts 32 are disposed with the gap 33 in the first direction D1 with long sides being aligned in parallel, and the oxygen electrode parts 22 are also disposed with the gap 23 in the first direction D1 with long sides being aligned in parallel. Additionally, the hydrogen electrode parts 32 are electrically connected to each other by a second conductive member 35. The cross-sectional shape of each hydrogen electrode part 32 in the cross-section PL perpendicular to the third direction D3 is a rectangular shape. Even in this case, an oblong shape and a square are included in the rectangular shape. The hydrogen electrode part 32 is a second electrode part.

In a case where the oxygen generation electrode 20 and the hydrogen generation electrode 30 are seen from a second direction D2 perpendicular to the first plane 21 and the second plane 31, the oxygen electrode parts 22 and the hydrogen electrode parts 32 are alternately disposed. That is, a hydrogen electrode part 32 of the hydrogen generation electrode 30 is disposed in the gap 23 of the oxygen generation electrode 20, and an oxygen electrode part 22 of the oxygen generation electrode 20 is disposed in the gap 33 of the hydrogen generation electrodes 30.

The oxygen generation electrode 20 and the hydrogen generation electrode 30 are provided on a front surface 17a of a substrate 17. In this case, both the first plane 21 and the second plane 31 are the front surface 17a of the substrate 17. The oxygen generation electrode 20 and the hydrogen generation electrode 30 are disposed on the same surface. In addition, although the first plane 21 is a virtual plane on which the oxygen generation electrode 20 is provided, the first plane also includes a substantial surface, such as an object surface. In addition, although the second plane 31 is a virtual plane on which the hydrogen generation electrode 30 is provided, the second plane also includes a substantial surface, such as an object surface.

The substrate 17 is provided on a bottom surface 12c of the inside 12a of the container 12. The front surface 17a of the substrate 17 is parallel to the horizontal plane B.

Here, the third direction D3 is a direction perpendicular to both the first direction D1 and the second direction D2.

An electrode spacing δ between the oxygen electrode part 22 of the oxygen generation electrode 20 and the hydrogen electrode part 32 of the hydrogen generation electrode 30 is more than 5 μm and less than 1 mm. The electrode spacing δ is preferably more than 5 μm and 500 μm or less, and more preferably more than 5 μm and 200 μm or less.

As long as the electrode spacing δ is more than 5 μm and less than 1 mm, pH (hydrogen ion exponent) gradient can be suppressed, electrolysis voltage can be reduced, and salting-out and reverse reaction can be suppressed. Accordingly, the efficiency of the oxygen generation electrode 20 and the hydrogen generation electrode 30 can be made high.

Here, the efficiency is the generation efficiency of the hydrogen, and the generation efficiency of the oxygen, which are obtained from the oxygen generation electrode 20 and the hydrogen generation electrode 30.

Additionally, it is preferable that one or more and less than fifty pairs 39 of the oxygen electrode parts 22 and the hydrogen electrode parts 32 are included per 1 mm in length in the first direction D1.

Although the electrode spacing δ is important, for example, in a case where electrode width is 10 times the electrode spacing δ, the other electrode, which faces a central part of one electrode out of the oxygen generation electrode 20 and the hydrogen generation electrode 30, is separated at a distance corresponding to a position separated by a parameter Q. Therefore, it is preferable that one or more and less than fifty pairs 39 of the oxygen electrode parts 22 and the hydrogen electrode parts 32 are included per 1 mm.

For example, in a case where the electrode spacing δ is 5 μm and the electrode width is 5 μm, one electrode, a gap, another electrode, and a gap are disposed in this order every 20 μm. In this case, about fifty pairs 39 of the oxygen electrode parts 22 and the hydrogen electrode parts 32 are present per 1 mm.

The above-described parameter Q is Parameter Q=(Electrode spacing δ)+(Electrode width of one electrode)/2+(Electrode width of another electrode)/2.

The above-described electrode width is the length of an electrode in the first direction D1.

In addition, it is meant that, as the electrolysis voltage is smaller, the electrolysis efficiency of the water AQ is higher.

The salting-out is that, in a case where there is a salt dissolved in an electrolytic solution, the salt precipitates to at least one of the oxygen generation electrode 20 and the hydrogen generation electrode 30 due to electrical field concentration. In a case where the salting-out occurs, the effective area of an electrode part utilized for oxygen generation or hydrogen generation decreases. In a case where the salting-out is repeatedly used, the salting-out becomes an index of durability.

The reverse reaction is a reaction in which H₂ and O₂ react with each other and return to H₂O (water). In a case where the reverse reaction occurs, the generation amount of the hydrogen and the generation amount of the oxygen decreases, and the efficiency degrades.

In the artificial photosynthesis module 10 illustrated in FIG. 1, the electrode spacing δ is the distance in the first direction D1 between the oxygen electrode part 22 and the hydrogen electrode part 32 that are adjacent to each other. However, the gap equivalent to the electrode spacing δ between the oxygen electrode part 22 and the hydrogen electrode part 32 is not necessarily uniform in the third direction D3. For this reason, the electrode spacing δ is defined as an average value of lengths of the above-described gap. The average value of lengths of the above-described gap is, for example, an average value of lengths of the gap at twenty points.

The electrode spacing S can be obtained as follows.

First, a digital image in a case where the oxygen electrode part 22 and the hydrogen electrode part 32 are seen from the second direction D2 in a state illustrated in FIG. 2 is acquired. The digital image is taken into a personal computer, and a profile of the oxygen electrode part 22 and a profile of the hydrogen electrode part 32 are extracted by the computer. The length of a gap equivalent to the electrode spacing S between the oxygen electrode part 22 and the hydrogen electrode part 32 in the third direction D3 is determined with respect to the extracted profile of the oxygen electrode part 22 and the extracted profile of the hydrogen electrode part 32. Next, the average value of lengths of the above-described gap is determined, and the electrode spacing S is obtained. The average value of lengths of the above-described gap is, for example, an average value of lengths of the gap at twenty points.

As long as the container 12 can hold the water AQ in the inside 12a thereof and can radiate the light L to the oxygen generation electrode 20 and the hydrogen generation electrode 30 that are present in the inside 12a, the container is not particularly limited in configuration and is made of, for example, polyacrylate. It is preferable at least a surface 12b of the container 12 on an incidence side of the light L satisfies the definition of transparency.

The substrate 17 supports the oxygen generation electrode 20 and the hydrogen generation electrode 30. As long as the substrate 17 can support the oxygen generation electrode 20 and the hydrogen generation electrode 30, the substrate is not particularly limited in configuration and is made of glass. Additionally, a configuration in which the oxygen generation electrode 20 and the hydrogen generation electrode 30 may be provided on the bottom surface 12c of the container 12 without providing the substrate 17 may be adopted.

Distilled water, cooling water to be used in a cooling tower, and the like are included in the water AQ. Additionally, an electrolytic aqueous solution is also included in the water AQ. Here, the electrolytic aqueous solution is a liquid having H₂O as a main component, may be an aqueous solution having water as a solvent and containing a solute, and is, for example, an electrolytic solution containing strong alkali (KOH (potassium hydroxide)) and H₂SO₄, a sodium sulfate electrolytic solution, a potassium phosphate buffer solution, or the like. As the electrolytic aqueous solution, the potassium phosphate electrolytic solution adjusted to pH 7 is preferable.

Additionally, for example, an electrolytic solution having an electrical conductivity of 200 mS/cm (millisiemens per centimeter) or less can be used for the water AQ. The electrical conductivity of the electrolytic solution used as the water AQ is preferably 100 mS/cm or less and more preferably 20 mS/cm or less. As long as the electrical conductivity is 200 mS/cm or less, the effect of suppressing the electrolysis of water is great even in a case where the electrode spacing δ is small, the salt precipitation can be suppressed, and the safety is also excellent. In addition, a lower limit value of electrical conductivity is, for example, a value of the electrical conductivity of pure water, and is 1 μS/cm at the temperature of 25° C.

The electrical conductivity can be measured using a portable electrical conductivity meter ES-71 (trade name) made by Horiba Ltd. Additionally, the electrical conductivity is a value at the temperature of 20° C.

Next, a second example of the artificial photosynthesis module will be described. In the second example of the artificial photosynthesis module, similarly to the first example of the above-described artificial photosynthesis module, the raw material fluid is water, the first fluid is oxygen, and the second fluid is hydrogen.

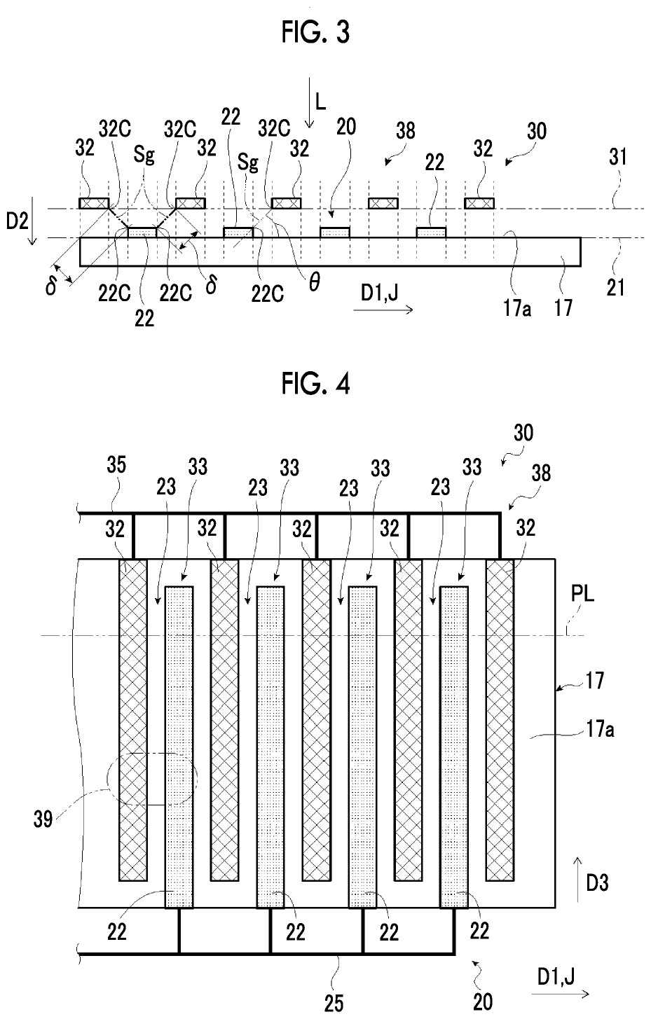

FIG. 3 is a schematic cross-sectional view illustrating the second example of the electrode arrangement configuration of the artificial photosynthesis module of the embodiment of the invention, and FIG. 4 is a schematic plan view illustrating the second example of the electrode arrangement configuration of the artificial photosynthesis module of the embodiment of the invention. FIG. 3 illustrates the cross-section PL perpendicular to the third direction D3 of FIG. 4.

In addition, in the electrode arrangement configuration of the oxygen generation electrode 20 and the hydrogen generation electrode 30 illustrated in FIGS. 3 and 4, the same components as those of the artificial photosynthesis module 10 illustrated in FIG. 1 and the oxygen generation electrode 20 and the hydrogen generation electrode 30 illustrated in FIG. 2 will be designated by the same reference signs, and the detailed description thereof will be omitted.

The second example of the artificial photosynthesis module has the same configuration as the above-described artificial photosynthesis module 10 except having the oxygen generation electrode 20 and the hydrogen generation electrode 30 that are illustrated in FIGS. 3 and 4.

As illustrated in FIG. 3, the first plane 21 of the oxygen generation electrode 20 and the second plane 31 of the hydrogen generation electrode 30 are spaced apart from each other in the second direction D2, and the oxygen generation electrode 20 and the hydrogen generation electrode 30 are disposed to be spaced apart from each other in the second direction D2. In addition, a method by which the oxygen generation electrode 20 and the hydrogen generation electrode 30 are disposed to be spaced apart from each other in the second direction D2 is not particularly limited. The oxygen generation electrode 20 and the hydrogen generation electrode 30 may be disposed on the incidence side of the light L, for example, by being disposed and formed on a transparent substrate.

By disposing the oxygen generation electrode 20 and the hydrogen generation electrode 30 to be spaced apart from each other, the electrode spacing δ between the oxygen generation electrode 20 and the hydrogen generation electrode 30 can be made wider than the electrode spacing δ of the artificial photosynthesis module 10. Accordingly, the electrical field concentration can be suppressed, and the salting-out can be further suppressed. Therefore, a decrease in the effective area of an electrode part can be suppressed as compared to the above-described artificial photosynthesis module 10. As described above, since the electrode spacing δ can be made wide, the reverse reaction can be inhibited in addition to further suppressing the salting-out.

Additionally, by disposing the oxygen generation electrode 20 and the hydrogen generation electrode 30 to be spaced apart from each other, compared to the artificial photosynthesis module 10, the length of the oxygen electrode part 22 in the first direction D1 and the length of the hydrogen electrode part 32 in the first direction D1 can also be increased, and the effective area of an electrode part can be increased.

In addition, in the electrode arrangement configuration of the oxygen generation electrode 20 and the hydrogen generation electrode 30 that are illustrated in FIGS. 3 and 4, as illustrated in FIG. 3, the electrode spacing δ is the shortest length of an end part 22C of the oxygen electrode part 22 of the oxygen generation electrode 20 and an end part 32C of the hydrogen electrode part 32 of the hydrogen generation electrode 30, which are adjacent to each other. The above-described shortest length is the length of a line segment Sg to be described below.

In the electrode arrangement configuration of the oxygen generation electrode 20 and the hydrogen generation electrode 30 that are illustrated in FIGS. 3 and 4, as for the above-described shortest length, a digital image of the oxygen generation electrode 20 and the hydrogen generation electrode 30 as seen from the third direction D3 is acquired. The digital image is taken into a personal computer, and a profile of the oxygen electrode part 22 and a profile of the hydrogen electrode part 32 are extracted by the computer. The end part 22C is obtained from the extracted profile of the oxygen electrode part 22, and the end part 32C is obtained from the extracted profile of the hydrogen electrode part 32. Next, the line segment Sg at which a distance between the end part 22C of the oxygen electrode part 22 and the end part 32C of the hydrogen electrode part 32 becomes the shortest is obtained. The electrode spacing δ is obtained by determining the length of the line segment Sg.

Even in the electrode arrangement configuration of the oxygen generation electrode 20 and the hydrogen generation electrode 30 that are illustrated in FIGS. 3 and 4, the electrode spacing δ is more than 5 μm and less than 1 mm, preferably more than 5 μm and 500 μm or less, and more preferably more than 5 μm and 200 μm or less. As long as the electrode spacing δ is more than 5 μm and less than 1 mm, the pH gradient can be suppressed, the electrolysis voltage can be reduced, the salting-out and the reverse reaction can be suppressed, and high efficiency can be obtained.

In addition, in the electrode arrangement configuration of the oxygen generation electrode 20 and the hydrogen generation electrode 30 that are illustrated in FIGS. 3 and 4, compared to the above-described artificial photosynthesis module 10, passing-through of the generated oxygen and hydrogen is excellent, and the area of the oxygen generation electrode 20 and the hydrogen generation electrode 30 can be effectively utilized. In this way, the effective area of an electrode part utilized for oxygen generation or hydrogen generation can be increased.

The above-described line segment Sg varies in length depending on an inclination angle θ of the line segment Sg. In a case where the inclination angle is defined as θ, the area can be effectively utilized by 1/cos θ as compared to the above-described artificial photosynthesis module 10. For this reason, in a case where the inclination angle θ is 45°, the area of the oxygen generation electrode 20 and the hydrogen generation electrode 30 can be utilized effectively by 1/√2. It is preferable that the inclination angle θ is 45° to 90°. In a case where the inclination angles θ is 45° to 90°, passing-through of the generated oxygen and hydrogen is excellent, and the area of the oxygen generation electrode 20 and the hydrogen generation electrode 30 can be effectively utilized. The inclination angle θ is an angle formed between the line segment Sg and the first plane 21. In a case where the line segment Sg is determined as described above, the inclination angle θ can be obtained by extending the line segment Sg to the first plane 21.

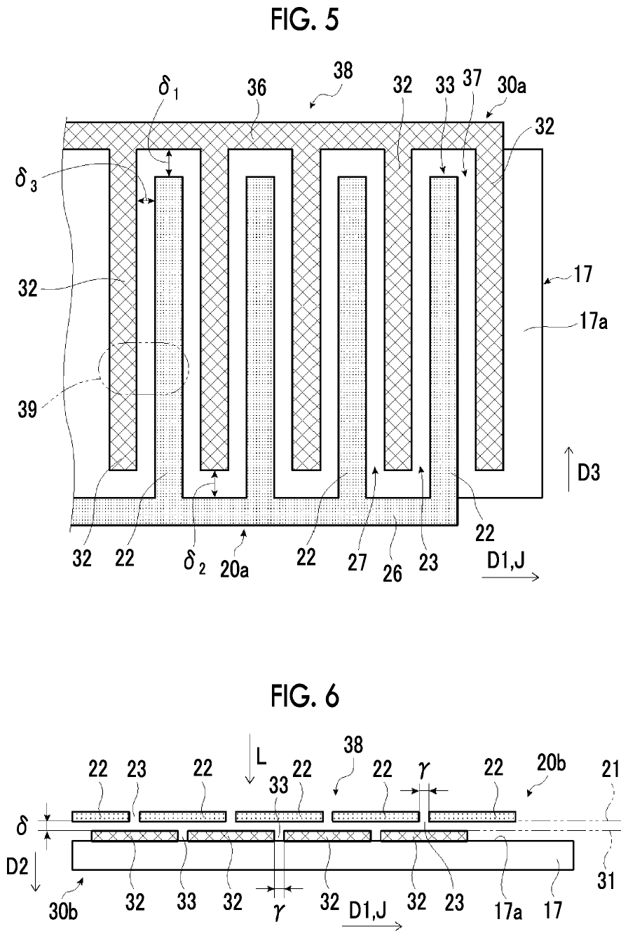

In both the oxygen generation electrode 20 illustrated in FIG. 2 and the oxygen generation electrode 20 illustrated in FIG. 4, the oxygen electrode parts 22 are electrically connected to each other by the first conductive member 25. However, a comb-shaped structure may be adopted as in an oxygen generation electrode 20a illustrated in FIG. 5.

The oxygen generation electrode 20a illustrated in FIG. 5 further has a flat plate-shaped oxygen electrode base material part 26 that extends in the first direction D1. The oxygen electrode base material part 26 extending in the first direction D1 is connected to respective end parts of each of the plurality of oxygen electrode parts 22. The oxygen electrode base material part 26 has a flat plate shape similarly to the oxygen electrode part 22, and the oxygen electrode part 22 and the oxygen electrode base material part 26 are integral with each other. A first recess 27 is constituted by the oxygen electrode parts 22 and the oxygen electrode base material part 26.

In addition, the oxygen electrode base material part 26 may have the same configuration as or may have a different configuration from the oxygen electrode part 22. In a case where the oxygen electrode base material part 26 has a configuration different from the oxygen electrode part 22, the oxygen electrode base material part 26 can be utilized as a collecting electrode similarly to the first conductive member 25. The oxygen electrode base material part 26 is a first electrode base material part.

In both the hydrogen generation electrode 30 illustrated in FIG. 2 and the hydrogen generation electrode 30 illustrated in FIG. 4, the hydrogen electrode parts 32 are electrically connected to each other by the second conductive member 35. However, a comb-shaped structure may be adopted as in a hydrogen generation electrode 30a illustrated in FIG. 5.

The hydrogen generation electrode 30a illustrated in FIG. 5 further has a flat plate-shaped hydrogen electrode base material part 36 that extends in the first direction D1. The hydrogen electrode base material part 36 extending in the first direction D1 is connected to respective end parts of the plurality of hydrogen electrode parts 32. The hydrogen electrode base material part 36 has a flat plate shape similarly to the hydrogen electrode part 32, and the hydrogen electrode part 32 and the hydrogen electrode base material part 36 are integral with each other. A second recess 37 is constituted by the hydrogen electrode parts 32 and the hydrogen electrode base material part 36.

In addition, the hydrogen electrode base material part 36 may have the same configuration as or may have a different configuration from the hydrogen electrode part 32. In a case where the hydrogen electrode base material part 36 has a configuration different from the hydrogen electrode part 32, the hydrogen electrode base material part 36 can be utilized as a collecting electrode similarly to the second conductive member 35. The hydrogen electrode base material part 36 is a second electrode base material part.

In the oxygen generation electrode 20a and the hydrogen generation electrode 30a that are illustrated in FIG. 5 as seen from the second direction D2 (refer to FIG. 1), the hydrogen electrode part 32 enters the first recess 27 of the oxygen generation electrode 20, and the oxygen electrode part 22 enters the second recess 37 of the hydrogen generation electrode 3.

As illustrated in FIG. 5, by forming the oxygen generation electrode 20a and the hydrogen generation electrode 30a as the comb-shaped structure, the oxygen generation electrode 20a and the hydrogen generation electrode 30a can be accurately made by a simple process, such as screen printing.

In addition, in the case of the comb-shaped structure illustrated in FIG. 5, the above-described electrode spacing δ is an average value of a spacing δ₁ between the oxygen electrode part 22 and the hydrogen electrode base material part 36, a spacing δ₂ between the hydrogen electrode part 32 and the first conductive member, and a distance δ₃ between the oxygen electrode part 22 and the hydrogen electrode part 32 that are adjacent to each other.

The above-described spacing δ₁, spacing δ₂, and distance δ₃ may be, for example, average values of measurement values at twenty points, respectively.

The spacing δ₁ between the oxygen electrode part 22 and the hydrogen electrode base material part 36, the spacing δ₂ between the hydrogen electrode part 32 and the first conductive member, and the distance δ₃ between the oxygen electrode part 22 and the hydrogen electrode part 32 that are adjacent to each other are the same when the above-described electrode spacing δ is determined, and a digital image as seen from the second direction D2 in a state illustrated in FIG. 2 is acquired with respect to the oxygen generation electrode 20a and the hydrogen generation electrode 30a that are illustrated in FIG. 5. The digital image is taken into a personal computer, and a profile of the oxygen electrode part 22 and a profile of the hydrogen electrode part 32 are extracted by the computer. On the basis of the extracted profile of the oxygen electrode part 22 and the extracted profile of the hydrogen electrode part 32, the electrode spacing δ is obtained by determining the above-described spacing δ₁, spacing δ2, and distance δ₃ and further determining the average value of the spacing δ₁, the spacing δ₂, and the distance δ₃.

In FIG. 5, both the oxygen generation electrode 20a and the hydrogen generation electrode 30a have the comb-shaped structure the invention is not limited to this. At least one electrode out of the oxygen generation electrode 20a and the hydrogen generation electrode 30a may have the comb-shaped structure. In this case, as seen from the second direction D2, an electrode arrangement configuration in which the hydrogen electrode part 32 enters the first recess or the oxygen electrode part 22 enters the second recess is adopted.

Next, a third example of the artificial photosynthesis module will be described. In the third example of the artificial photosynthesis module, similarly to the first example of the above-described artificial photosynthesis module, the raw material fluid is water, the first fluid is oxygen, and the second fluid is hydrogen.

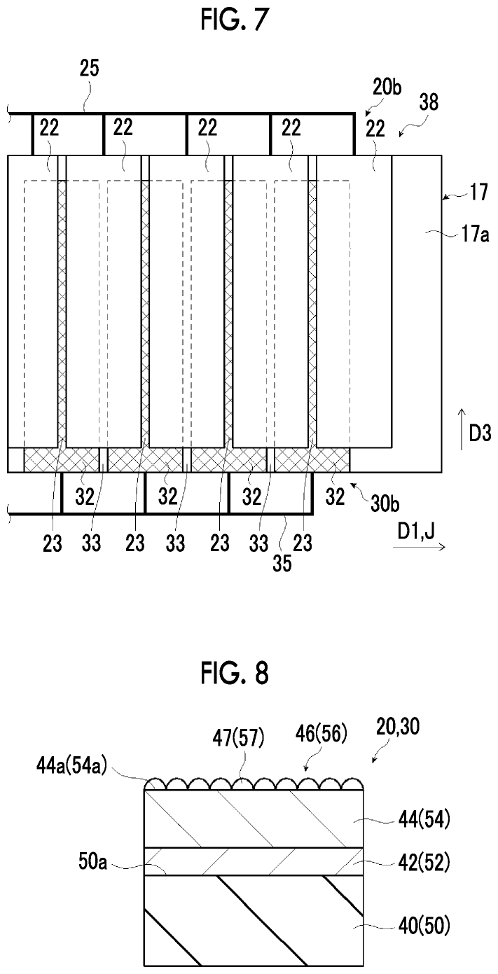

FIG. 6 is a schematic cross-sectional view illustrating the third example of the electrode arrangement configuration of the artificial photosynthesis module of the embodiment of the invention, and FIG. 7 is a schematic plan view illustrating the third example of the electrode arrangement configuration of the artificial photosynthesis module of the embodiment of the invention. FIG. 6 illustrates the cross-section PL perpendicular to the third direction D3 of FIG. 7.

In addition, in the electrode arrangement configuration of an oxygen generation electrode 20b and a hydrogen generation electrode 30b illustrated in FIGS. 6 and 7, the same components as those of the artificial photosynthesis module 10 illustrated in FIG. 1 and the oxygen generation electrode 20 and the hydrogen generation electrode 30 illustrated in FIG. 2 will be designated by the same reference signs, and the detailed description thereof will be omitted.

The third example of the artificial photosynthesis module has the same configuration as the above-described artificial photosynthesis module 10 except having the oxygen generation electrode 20 and the hydrogen generation electrode 30 that are illustrated in FIGS. 6 and 7.

In the oxygen generation electrode 20b illustrated in FIG. 6, the oxygen electrode part 22 is longer in the first direction D1 and wider in electrode width than the oxygen electrode part 22 of the oxygen generation electrode 20 illustrated in FIG. 1. In the hydrogen generation electrode 30b, the hydrogen electrode part 32 is longer in the first direction D1 and wider in electrode width than the hydrogen electrode part 32 of the hydrogen generation electrode 30 illustrated in FIG. 1.

The oxygen electrode parts 22 are disposed with the gap 23 in the first direction D1. The hydrogen electrode parts 32 are disposed with the gap 33 in the first direction D1. Both the above-described gap 23 and gap 33 are spaces different from the electrode spacing δ. It is preferable that lengths γ of both the above-described gap 23 and gap 33 in the first direction D1 are 10 μm or more. By providing the above-described gap 23 and gap 33, escape of the generated oxygen and hydrogen is excellent. Accordingly, stagnation of the generated oxygen and hydrogen in the form of bubbles can be suppressed, and blocking of the light L by the bubbles can be suppressed. For this reason, influence of the generated oxygen and hydrogen on the reaction efficiency can be made small.

As illustrated in FIG. 6, the first plane 21 of the oxygen generation electrode 20b and the second plane 31 of the hydrogen generation electrode 30b are spaced apart from each other in the second direction D2, and the oxygen generation electrode 20b and the hydrogen generation electrode 30b are disposed to be spaced apart from each other in the second direction D2.

Moreover, the oxygen generation electrode 20b and the hydrogen generation electrode 30b are disposed such that at least portions thereof overlap each other in the first direction D1.

The oxygen generation electrode 20b or the hydrogen generation electrode 30b, which is disposed on the incidence side of light out of the oxygen generation electrode 20b and the hydrogen generation electrode 30b, transmits light. As illustrated in FIGS. 6 and 7, the oxygen generation electrode 20b is disposed above the hydrogen generation electrode 30b, and the oxygen generation electrode 20b transmits light.

In addition, a configuration in which the hydrogen generation electrode 30b is disposed above the oxygen generation electrode 20 may be adopted. In this case, a configuration in which the hydrogen generation electrode 30b transmits light is adopted.

Here, the “transmits light” means that the light transmittance is 60% or more in a region having a wavelength of 380 nm to 780 nm. The above-described light transmittance is measured by a spectrophotometer. As the spectrophotometer, for example, V-770 (product name), which is an ultraviolet-visible spectrophotometer manufactured by JASCO Corporation, is used. In addition, in a case where the transmittance is T %, the transmittance is expressed by T=(Σλ, (Measurement substance+Substrate)/Σλ (Substrate))×100%. The above-described measurement substance is a glass substrate, and a substrate reference is air. The range of integration is up to a light-receiving wavelength of a photocatalyst layer, in light having a wavelength of 380 nm to 780 nm. In addition, Japanese Industrial Standard (JIS) R 3106-1998 can be referred to for the measurement of the transmittance.

By using the oxygen generation electrode 20b having the oxygen electrode part 22 with a large electrode width and the hydrogen generation electrode 30b having the hydrogen electrode part 32 with a large electrode width, which are illustrated in FIGS. 6 and 7, the effective area of an electrode part utilized for oxygen generation and hydrogen generation can be increased compared to the first example of the above-described artificial photosynthesis module and the second example of the artificial photosynthesis module. Accordingly, as long as the sizes of artificial photosynthesis modules are the same, in the third example of the artificial photosynthesis module, the generation efficiency of the oxygen and the generation efficiency of the hydrogen can be made high compared to the first example of the above-described artificial photosynthesis module and the second example of the artificial photosynthesis module.

In the electrode arrangement configuration of the oxygen generation electrode 20b and the hydrogen generation electrode 30b that are illustrated in FIGS. 6 and 7, an average value of separation distances between the oxygen generation electrode 20b and the hydrogen generation electrode 30b in the second direction D2 is the electrode spacing δ.

Even in the electrode arrangement configuration of the oxygen generation electrode 20b and the hydrogen generation electrode 30b that are illustrated in FIGS. 6 and 7, the electrode spacing δ is 5 μm and less than 1 mm, preferably more than 5 μm and 500 μm or less, and more preferably more than 5 μm and 200 μm or less. As long as the electrode spacing δ is more than 5 μm and less than 1 mm, the pH gradient can be suppressed, the electrolysis voltage can be reduced, the salting-out and the reverse reaction can be suppressed, and the efficiency of the oxygen generation electrode 20b and the hydrogen generation electrode 30b can be obtained.

As for the electrode spacing δ, similarly to the above-described electrode spacing δ, a digital image of the oxygen generation electrode 20b and the hydrogen generation electrode 30b as seen from the third direction D3 is acquired. The digital image is taken into a personal computer, and a profile of the oxygen electrode part 22 and a profile of the hydrogen electrode part 32 are extracted by the computer. A separation distance equivalent to the electrode spacing δ between the oxygen electrode part 22 and the hydrogen electrode part 32 in the first direction D1 is determined with respect to the extracted profile of the oxygen electrode part 22 and the extracted profile of the hydrogen electrode part 32. Next, the electrode spacing δ is obtained by determining an average value of the above-described separation distances.

In addition, in the first example of the above-described artificial photosynthesis module to the third example of the artificial photosynthesis module, the container 12 (refer to FIG. 1) may be disposed so as to be tilted at a specific angle with respect to the horizontal plane B (refer to FIG. 1). Accordingly, for example, it is easy to recover the oxygen and the hydrogen that are generated as gas. Additionally, the generated oxygen can be rapidly moved from the oxygen generation electrode 20, and the generated hydrogen can be rapidly moved from the hydrogen generation electrode 30. Accordingly, stagnation of the generated oxygen and hydrogen in the form of bubbles can be suppressed, and blocking of the light L by the bubbles can be suppressed. For this reason, influence of the generated oxygen and hydrogen on the reaction efficiency can be made small.

The effect obtained by disposing the above-described container 12 (referring to FIG. 1) at a specific angle so as to be tilted with respect to the horizontal plane B (refer to FIG. 1) is not limited to oxygen and hydrogen, and the same effect can be obtained in a case where gas is generated by decomposing a fluid to be treated with light.

Hereinafter, the oxygen generation electrode that is an example of the first electrode, and the hydrogen generation electrode that is an example of the second electrode will be described in detail.

FIG. 8 is a schematic cross-sectional view illustrating an example of an electrode structure of the artificial photosynthesis module of the embodiment of the invention. In addition, since the oxygen generation electrode and the hydrogen generation electrode have the same configuration, these electrodes are illustrated in a single figure of FIG. 8. Both the oxygen generation electrode 20 and the hydrogen generation electrode 30 may have layers other than the configurations shown below, and may have, for example, a configuration having a contact layer or a protective layer.

<Electrode Structure>

As illustrated in FIG. 8, the oxygen generation electrode 20 has a first substrate 40, a first conductive layer 42 provided on the first substrate 40, a first photocatalyst layer 44 provided on the first conductive layer 42, and a first co-catalyst 46 that is carried and supported on at least a portion of the first photocatalyst layer 44. The configuration of the oxygen electrode part 22 is the same as the configuration of the oxygen generation electrode 20 of FIG. 8 described above. The arrangement of the oxygen generation electrode 20 is appropriately determined depending on an arrangement form with the hydrogen generation electrode 30, or the like, and is not particularly limited. The oxygen generation electrode 20 may have, for example, an arrangement in which the light L (refer to FIG. 1) is incident from the first co-catalyst 46 side, or an arrangement in which the light L (refer to FIG. 1) is incident from the first substrate 40 side.

The first co-catalyst 46 is provided on a front surface 44a of the first photocatalyst layer 44. The first co-catalyst 46 is constituted by, for example, a plurality of co-catalyst particles 47. In the oxygen generation electrode 20, it is also preferable to have a configuration having a pn junction. Individual components of the oxygen generation electrode 20 will be described below in detail.

As illustrated in FIG. 8, the hydrogen generation electrode 30 has a second substrate 50, a second conductive layer 52 provided on the second substrate 50, a second photocatalyst layer 54 provided on the second conductive layer 52, and a second co-catalyst 56 that is carried and supported on at least a portion of the second photocatalyst layer 54. The configuration of the hydrogen electrode part 32 is the same as the configuration of the hydrogen generation electrode 30 of FIG. 8 described above. The arrangement of the hydrogen generation electrode 30 is appropriately determined depending on an arrangement form with the oxygen generation electrode 20, or the like, and is not particularly limited. The hydrogen generation electrode 30 may have, for example, an arrangement in which the light L (refer to FIG. 1) is incident from the second co-catalyst 56 side, or an arrangement in which the light L (refer to FIG. 1) is incident from the second substrate 50 side.

The second co-catalyst 56 is provided on a front surface 54a of the second photocatalyst layer 54. The second co-catalyst 56 is constituted by, for example, a plurality of co-catalyst particles 57.

In the hydrogen generation electrode 30, carriers created in a case where the light L is absorbed are generated, and the water AQ is decomposed to generate hydrogen. It is also preferable that the hydrogen generation electrode 30 is configured to have a pn junction by laminating a material having n-type conductivity on the front surface 54a of the second photocatalyst layer 54. Individual components of the hydrogen generation electrode 30 will be described below in detail.

Out of the oxygen generation electrode 20 and the hydrogen generation electrode 30, both may be configured to have a pn junction or at least one may be configured to have a pn junction.

In addition, in the configuration illustrated in the above-described FIG. 6 in the oxygen generation electrode 20 on the side where the light L is incident, the first co-catalyst 46 is configured to be disposed on a side opposite to an incidence direction of the light L. Accordingly, a decrease in the amount of incidence of the light L to the oxygen generation electrode 20 is suppressed. In the oxygen generation electrode 20, the light L is incident from the first photocatalyst layer 44 side. In the hydrogen generation electrode 30, the light L is incident from the second co-catalyst 56, and reaches the second photocatalyst layer 54. For this reason, in the configuration illustrated in FIG. 6, the first substrate 40 and the first conductive layer 42 of the oxygen generation electrode 20 need to have light transmittance. However, in the hydrogen generation electrode 30, the second conductive layer 52 and the second substrate 50 do not need to transmit light.

<Oxygen Generation Electrode>

Next, the first substrate, the first conductive layer, the first photocatalyst layer, and the first co-catalyst, which are suitable for the oxygen generation electrode 20, will be described.

<First Substrate of Oxygen Generation Electrode>

For example, glass plates, such as high strain point glass and non-alkali glass, or a polyimide material is used for the first substrate.

<First Conductive Layer of Oxygen Generation Electrode>

The first conductive layer 42 supports a photocatalyst layer and a coating layer, and well-known conductive layers can be used. For example, it is preferable to use conductive layers formed of metals, nonmetals, such as carbon (graphite), or conductive materials, such as conductive oxides. In a case where the first conductive layer 42 is transparent, the first conductive layer is formed of transparent conductive oxides. It is preferable that, for example, SnO₂, indium tin oxide (ITO), fluorine-doped tin oxide (FTO), IMO (In₂O₃ doped with Mo), ZnO doped with Al, B, Ga, or In, or the like is used for above-described transparent conductive oxides. In addition, the transparence in the first conductive layer 42 is the same as the above-described transparence.

<First Photocatalyst Layer of Oxygen Generation Electrode>

As optical semiconductors constituting the first photocatalyst layer 44, well-known photocatalysts may be used, and optical semiconductors containing at least one kind of metallic element may be used.

Among these, from a viewpoint of more excellent onset potential, higher photocurrent density, or more excellent durability against continuous irradiation, as metallic elements, Ti, V, Nb, Ta, W, Mo, Zr, Ga, In, Zn, Cu, Ag, Cd, Cr, or Sn is preferable, and Ti, V, Nb, Ta, or W is more preferable.

Additionally, the optical semiconductors include oxides, nitrides, oxynitrides, sulfides, selenides, and the like, which contain the above-described metallic elements.

Additionally, the optical semiconductors are usually contained as a main component in the first photocatalyst layer. The main component means that the optical semiconductors are equal to or more than 80% by mass with respect to the total mass of the second photocatalyst layer, and preferably equal to or more than 90% by mass. Although an upper limit of the main component is not particularly limited, the upper limit is 100% by mass.

Specific examples of the optical semiconductors may include, for example, oxides, such as Bi₂WO₆, BiVO₄, BiYWO₆, In₂O₃(ZnO)₃, InTaO₄, and InTaO₄:Ni (“optical semiconductor: M” shows that the optical semiconductors are doped with M. The same applies below), TiO₂:Ni, TiO₂:Ru, TiO₂Rh, and TiO₂: Ni/Ta (“optical semiconductor: M1/M2” shows that the optical semiconductors are doped with M1 and M2. The same applies below), TiO₂:Ni/Nb, TiO₂:Cr/Sb, TiO₂:Ni/Sb, TiO₂:Sb/Cu, TiO₂:Rh/Sb, TiO₂:Rh/Ta, TiO₂:Rh/Nb, SrTiO₃:Ni/Ta, SrTiO₃:Ni/Nb, SrTiO₃:Cr, SrTiO₃:Cr/Sb, SrTiO₃:Cr/Ta, SrTiO₃:Cr/Nb, SrTiO₃:Cr/W, SrTiO₃:Mn, SrTiO₃:Ru, SrTiO₃:Rh, SrTiO₃:Rh/Sb, SrTiO₃:Ir, CaTiO₃:Rh, La₂Ti₂O₇:Cr, La₂Ti₂O₇:Cr/Sb, La₂Ti₂O₇:Fe, PbMoO₄:Cr, RbPb₂Nb₃O₁₀, HPb₂Nb₃O₁₀, PbBi₂Nb₂O₉, BiVO₄, BiCu₂VO₆, BiSn₂VO₆, SnNb₂O₆, AgNbO₃, AgVO₃, AgLi_{1/3}Ti_{2/3}O₂, AgLi_{1/3}Sn_{2/3}O₂, WO₃, BaBi₁₋ₓInₓO₃, BaZr₁₋ₓSnₓO₃, BaZr₁₋ₓGeₓO₃, and BaZr₁₋ₓSiₓO₃, oxynitrides, such as LaTiO₂N, Ca_{0.25}La_{0.75}TiO_{2.25}N_{0.75}, TaON, CaNbO₂N, BaNbO₂N, CaTaO₂N, SrTaO₂N, BaTaO₂N, LaTaO₂N, Y₂Ta₂O₅N₂, (Ga₁₋ₓZnₓ)(N₁₋ₓOₓ), (Zn₁₋ₓGe)(N₂Oₓ) (x represents a numerical value of 0 to 1), and TiNₓO_{y}F_{z}, nitrides, such as NbN and Ta₃N₅, sulfides, such as CdS, selenide, such as CdSe, oxysulfide compounds (Chemistry Letters, 2007, 36, 854 to 855) including Ln₂Ti₂S₂O₅ (Ln: Pr, Nd, Sm, Gd, Tb, Dy, Ho, and Er), La, and In, the optical semiconductors are not limited to the materials exemplified here.

Among these, as the optical semiconductors, BaBi₁₋ₓInₓO₃, BaZr₁₋ₓSnₓO₃, BaZr₁₋ₓGeₓO₃, BaZr₁₋ₓSiₓO₃, NbN, TiO₂, WO₃, TaON, BiVO₄, or Ta₃N₅, AB(O, N)₃ {A=Li, Na, K, Rb, Cs, Mg, Ca, Sr, Ba, La, or Y, B═Ta, Nb, Sc, Y, La, or Ti} having a perovskite structure; solid solutions including AB(O, N)₃ having the above-described perovskite structure as a main component; or doped bodies including TaON, BiVO₄, Ta₃N₅, or AB(O, N)₃ having the perovskite structure as a main component are preferable.

The shape of the optical semiconductors included in the first photocatalyst layer is not particularly limited, and includes a film shape, a columnar shape, a particle shape, and the like.

In a case where the optical semiconductors are particulate, the particle diameter of primary particles thereof is not particularly limited. However, usually, the particle diameter is preferably 0.01 μm or more, and more preferably, 0.1 μm or more, and usually, the particle diameter is preferably 10 μm or less and more preferably, 2 μm or less.

The above-described particle diameter is an average particle diameter, and is obtained by measuring the particle diameters (diameters) of any 100 optical semiconductors observed by a transmission electron microscope or a scanning electron microscope and arithmetically averaging these particle diameters. In addition, major diameters are measured in a case where the particle shape is not a true circle.

In a case where the optical semiconductors are columnar, it is preferable that the columnar optical semiconductors extend in a normal direction of the front surface of the first conductive layer. Although the diameter of the columnar optical semiconductors is not particularly limited, usually, the diameter is preferably 0.025 μm or more, and more preferably, 0.05 μm or more, and usually, the diameter is preferably 10 μm or less and more preferably, 2 μm or less.

The above-described diameter is an average diameter and is obtained by measuring the diameters of any 100 columnar optical semiconductors observed by the transmission electron microscope (Device name: H-8100 of Hitachi High Technologies Corporation) or the scanning electron microscope (Device name: SU-8020 type SEM of Hitachi High Technologies Corporation) and arithmetically averaging the diameters.

Although the thickness of the first photocatalyst layer is not limited, in the case of an oxide or a nitride, it is preferable that the thickness is 300 nm or more and 2 μm or less. In addition, the optimal thickness of the first photocatalyst layer is determined depending on the penetration length of the light L or the diffusion length of excited carriers.

Here, in many materials of the photocatalyst layer containing BiVO₄ used well as a material of the first photocatalyst layer, the reaction efficiency is not the maximum at such a thickness that all light having absorbable wavelengths can be utilized. In a case where the thickness is large, it is difficult to transport the carriers generated in a location distant from a film surface without deactivating the carriers up to the film surface, due to the problems of the lifespan and the mobility of the carriers. For that reason, even in a case where the film thickness is increased, an expected electric current cannot be taken out.

Additionally, in a particle transfer electrode that is used well in a particle system, the larger the particle diameter, the rougher the electrode film becomes. As the thickness, that is, the particle diameter increases, the film density decreases, and it is difficult to take out an expected electric current. The electric current can be taken out as long as the thickness of the first photocatalyst layer is 300 nm or more and 2 μm or less.

By acquiring a scanning electron microscope image of a cross-sectional state of a photocatalyst electrode, the thickness of the first photocatalyst layer can be obtained from the acquired image.

The above-described method for forming the first photocatalyst layer is not limited, and well-known methods (for example, a method for depositing particulate optical semiconductors on a substrate) can be adopted. The formation methods include, specifically, vapor phase film formation methods, such as an electron beam vapor deposition method, a sputtering method, and a chemical vapor deposition (CVD) method; a transfer method described in Chem. Sci., 2013, 4, and 1120 to 1124; and a method described in Adv. Mater., 2013, 25, and 125 to 131.

In addition, the other layer, for example, an adhesive layer may be included between the first substrate and the first photocatalyst layer as needed.

<First Co-Catalyst of Oxygen Generation Electrode>

As the first co-catalyst, noble metals and transition metal oxides are used. The first co-catalyst is carried and supported using a vacuum vapor deposition method, a sputtering method, an electrodeposition method, and the like. In a case where the first co-catalyst is formed with a set film thickness of, for example, about 1 nm to 5 nm, the first co-catalyst is not formed as films but become island-like.

As the first co-catalyst, for example, single substances constituted with Pt, Pd, Ni Au, Ag, Ru Cu, Co, Rh, Ir, Mn, Fe, or the like, alloys obtained by combining these single substances, and oxides and hydroxides of these single substances, for example, FeOx, CoOx such as CoO, NiOx, and RuO₂, and CoOOH, FeOOH, NiOOH and RuOOH may be used.

Next, the second substrate 50, the second conductive layer 52, the second photocatalyst layer 54, and the second co-catalyst 56 of the hydrogen generation electrode 30 will be described.

<Second Substrate of Hydrogen Generation Electrode>

The second substrate 50 of the hydrogen generation electrode 30 illustrated in FIG. 8 supports the second photocatalyst layer 54, and is configured to have an electrical insulating property. Although the second substrate 50 is not particularly limited, for example, a soda lime glass substrate or a ceramic substrate can be used. Additionally, a substrate in which an insulating layer is formed on a metal substrate can be used as the second substrate 50. Here, as the metal substrate, a metal substrate, such as an Al substrate or a steel use stainless (SUS) substrate, or a composite metal substrate, such as a composite Al substrate formed of a composite material of Al, and for example, other metals, such as SUS, is available. In addition, the composite metal substrate is also a kind of the metal substrate, and the metal substrate and the composite metal substrate are collectively and simply referred to as the metal substrate. Moreover, a metal substrate with an insulating film having an insulating layer formed by anodizing a surface of the Al substrate or the like can also be used as the second substrate 50. The second substrate 50 may be flexible or may not be flexible. In addition, in addition to the above-described substrates, for example, glass plates, such as high strain point glass and non-alkali glass, or a polyimide material can also be used as the second substrate 50.

The thickness of the second substrate 50 is not particularly limited, may be about 20 μm to 2000 μm, is preferably 100 μm to 1000 μm, and is more preferably 100 μM to 500 μm. In addition, in a case where one including a copper indium gallium (di) selenide (CIGS) compound semiconductor is used as the second photocatalyst layer 54, photoelectric conversion efficiency is improved in a case where alkali ions (for example, sodium (Na) ions: Na⁺) are supplied to the second substrate 50 side. Thus, it is preferable to provide an alkali supply layer that supplies the alkali ions to a front surface 50a of the second substrate 50. In addition, in a case where an alkali metal is included in the constituent elements of the second substrate 50, the alkali supply layer is unnecessary.

<Second Conductive Layer of Hydrogen Generation Electrode>

The second conductive layer 52 traps and transports the carriers generated in the second photocatalyst layer 54. Although the second conductive layer 52 is not particularly limited as long as the conductive layer has conductivity, the second conductive layer 52 is formed of, for example, metals, such as Mo, Cr, and W, or combinations thereof. The second conductive layer 52 may have a single-layer structure, or may have a laminate structure, such as a two-layer structure. Among these, it is preferable that the second conductive layer 52 is formed of Mo. It is preferable that the second conductive layer 52 has a thickness of 200 nm to 1000 nm.

<Second Photocatalyst Layer of Hydrogen Generation Electrode>

The second photocatalyst layer 54 generates carriers by light absorption, and a conduction band lower end there is closer to a base side rather than an electrical potential (H₂/H⁺) at which water is decomposed to generate hydrogen. Although the second photocatalyst layer 54 has p-type conductivity of generating holes and transporting the holes to the second conductive layer 52, it is also preferable to laminate the material having n-type conductivity on the front surface 54a of the second photocatalyst layer 54 to form a pn junction. The thickness of the second photocatalyst layer 54 is preferably 500 nm to 3000 nm.

The optical semiconductors constituting one having p-type conductivity are optical semiconductors containing at least one kind of metallic element. Among these, from a viewpoint of more excellent onset potential, higher photocurrent density, or more excellent durability against continuous irradiation, as metallic elements, Ti, V, Nb, Ta, W, Mo, Zr, Ga, In, Zn, Cu, Ag, Cd, Cr, or Sn is preferable, and Ga, In, Zn, Cu, Zr, or Sn is more preferable.

Additionally, the optical semiconductors include oxides, nitrides, oxynitrides, (oxy)chalcogenides, and the like including the above-described metallic elements, and is preferably constituted of GaAs, GaInP, AlGaInP, CdTe, CuInGaSe, CIGS compound semiconductors having a chalcopyrite crystal structure, or CZTS compound semiconductors, such as CuzZnSnS₄.

It is particularly preferable that the optical semiconductors are constituted of the CIGS compound semiconductors having a chalcopyrite crystal structure or the CZTS compound semiconductors, such as Cu₂ZnSnS₄.

The CIGS compound semiconductor layer may be constituted of CuInSe₂ (CIS), CuGaSe₂ (CGS), or the like as well as Cu(In, Ga)Se₂ (CIGS). Moreover, the CIGS compound semiconductor layer is may be configured by substituting all or part of Se with S.

In addition, as methods for forming the CIGS compound semiconductor layer, 1) a multi-source vapor deposition method, 2) a selenide method, 3) a sputtering method, 4) a hybrid sputtering method, 5) a mechanochemical process method, and the like are known.

Other methods for forming the CIGS compound semiconductor layer include a screen printing method, a proximity sublimating method, a metal organic chemical vapor deposition (MOCVD) method, a spraying method (wet film formation method), and the like. For example, in the screen printing method (wet film formation method), the spraying method (wet film formation method), or the like, crystal having a desired composition can be obtained by forming a particulate film including an 11 group element, a 13 group element, and a 16 group element on a substrate, and executing thermal decomposition processing (may be thermal decomposition processing in a 16 group element atmosphere in this case) or the like (JP1997-074065A (JP-H09-074065A), JP1997-074213A (JP-H09-074213A), or the like). Hereinafter, the CIGS compound semiconductor layer is also simply referred to as a CIGS layer.

In a case where the material having n-type conductivity is laminated on the front surface 54a of the second photocatalyst layer 54 as described above, the pn junction is formed.

It is preferable that the material having n-type conductivity is formed of one including metal sulfide including at least one kind of metallic element selected from a group consisting of, for example, Cd, Zn, Sn, and In, such as CdS, ZnS, Zn(S, O), and/or Zn/or (S, O, OH), SnS, Sn(S, O), and/or Sn/or (S, O, OH), InS, In (S, O), and/or In (S, O, OH). It is preferable that the film thickness of a layer of the material having n-type conductivity is 20 nm to 100 nm. The layer of the material having n-type conductivity is formed by, for example, a chemical bath deposition (CBD) method.

The configuration of the second photocatalyst layer 54 is not particularly limited as long as second photocatalyst layer 54 is formed of an inorganic semiconductor and can obtain hydrogen, such as causing a photocomposition reaction of water to generate hydrogen as gas.

For example, photoelectric conversion elements used for solar battery cells that constitute a solar battery are preferably used. As such photoelectric conversion elements, in addition to those using the above-described CIGS compound semiconductors or CZTS compound semiconductors such as Cu₂ZnSnS₄, thin film silicon-based thin film type photoelectric conversion elements, CdTe-based thin film type photoelectric conversion elements, dye-sensitized thin film type photoelectric conversion elements, or organic thin film type photoelectric conversion elements can be used.

<Second Co-Catalyst of Hydrogen Generation Electrode>

As the second co-catalyst 56, it is preferable that, for example, Pt, Pd, Ni, Ag, Ru, Cu, Co, Rh, Ir, Mn, and RuO₂ are used.

A transparent conductive layer (not illustrated) may be provided between the second photocatalyst layer 54 and the second co-catalyst 56. The transparent conductive layer needs a function of electrically connecting the second photocatalyst layer 54 and the second co-catalyst 56 to each other, transparency, water resistance, and water impermeability are also required for the transparent conductive layer, and the durability of the hydrogen generation electrode 30 is improved by the transparent conductive layer.

It is preferable that the transparent conductive layer is formed of, for example, metals, conductive oxides (of which the overvoltage is equal to or lower than 0.5 V), or composites thereof. The transparent conductive layer is appropriately selected in conformity with the absorption wavelength of the second photocatalyst layer 54. Transparent conductive films formed of ZnO that is doped with indium tin oxide (ITO), fluorine-doped tin oxide (FTO), Al, B, Ga, In, or the like, or IMO (In₂O₃ doped with Mo) can be used for the transparent conductive layer. The transparent conductive layer may have a single-layer structure, or may have a laminate structure, such as a two-layer structure. Additionally, the thickness of the transparent conductive layer is not particularly limited, and is preferably 30 nm to 500 nm.

In addition, although methods for forming the transparent conductive layer are not particularly limited, a vacuum film formation method is preferable. The transparent conductive layer can be formed by vapor phase film formation methods, such as an electron beam vapor deposition method, a sputtering method, and a chemical vapor deposition (CVD) method.

Additionally, instead of the transparent conductive layer, a protective film that protects the second co-catalyst 56 may be provided on a front surface of the second co-catalyst 56.

The protective film is configured in conformity with the absorption wavelength of the second co-catalyst 56. For example, oxides, such as TiO₂, ZrO₂, and Ga₂O₃, are used for the protective film. In a case where the protective film is an insulator, for example, the thickness thereof is 5 nm to 50 nm, and film formation methods, such as an atomic layer deposition (ALD) method, are selected. In a case where the protective film is conductive, for example, the protective film has a thickness of 5 nm to 500 nm, and may be formed by a sputtering method and the like in addition to the atomic layer deposition (ALD) method and a chemical vapor deposition (CVD) method. The protective film can be made thicker in a case where the protective film is a conductor than in a case where the protective film is insulating.

As illustrated in FIG. 6, in the case of the electrode arrangement configuration in which the oxygen generation electrode 20 and the hydrogen generation electrode 30 are overlapped with each other, an absorption end of the first photocatalyst layer 44 of the oxygen generation electrode 20 has, for example, about 500 nm to 800 nm, and an absorption end of the second photocatalyst layer 54 of the hydrogen generation electrode 30 has, for example, about 600 nm to 1300 nm.

Here, in a case where the absorption end of the first photocatalyst layer 44 of the oxygen generation electrode 20 is defined as λ₁ and the absorption end of the second photocatalyst layer 44 of the hydrogen generation electrode 30 is defined as 22, it is preferable that λ₁<λ₂ and λ₂-λ₁≥100 nm are satisfied. Accordingly, in a case where the light L is solar light, even in a case where light having a specific wavelength is previously absorbed by the first photocatalyst layer 54 of the oxygen generation electrode 20 and is utilized for generation of oxygen, the light L can be absorbed by the second photocatalyst layer 54 of the hydrogen generation electrode 30 and can be utilized for generation of hydrogen, and a required carrier creation amount is obtained in the hydrogen generation electrode 30. Accordingly, the utilization efficiency of the light L can be further enhanced.

<Electrode Cross-Section Configuration>

Cross-sections of the oxygen electrode part 22 of the oxygen generation electrode 20 and the hydrogen electrode part 32 of the hydrogen generation electrode 30 perpendicular to the third direction D3 are, for example, rectangular shapes, triangular shapes, convex shapes, semicircular shapes, or round shapes. The cross-sectional shapes of the oxygen electrode part 22 illustrated in FIGS. 1 and 2 and the hydrogen electrode part 32 are rectangular shapes.

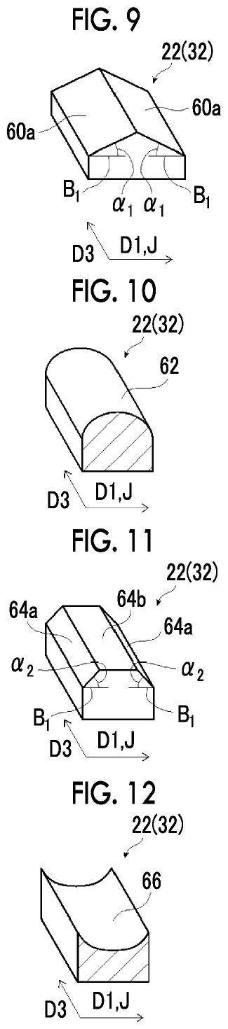

FIG. 9 is a schematic perspective view illustrating a first example of an electrode configuration of the artificial photosynthesis module of the embodiment of the invention, FIG. 10 is a schematic perspective view illustrating a second example of the electrode configuration of the artificial photosynthesis module of the embodiment of the invention, FIG. 11 is a schematic perspective view illustrating a third example of the electrode configuration of the artificial photosynthesis module of the embodiment of the invention, and FIG. 12 is a schematic perspective view illustrating a fourth example of the electrode configuration of the artificial photosynthesis module of the embodiment of the invention.

In addition, in the oxygen electrode part 22 of the oxygen generation electrode 20 and the hydrogen electrode part 32 of the hydrogen generation electrode 30 illustrated in FIGS. 9 to 12, the same components as those of the oxygen generation electrode 20 and the hydrogen generation electrode 30 illustrated in FIG. 2 will be designated by the same reference signs, and the detailed description thereof will be omitted.

FIGS. 9 to 12 are for illustrating the cross-sectional shapes of the oxygen electrode part 22 of the oxygen generation electrode 20 and the hydrogen electrode part 32 of the hydrogen generation electrode 30, and omit illustration of the detailed configuration.

End surfaces of FIGS. 9 to 12 have cross-sectional shapes in cross-sections PL (refer to FIG. 2) of the oxygen electrode part 22 of the oxygen generation electrode 20 and the hydrogen electrode part 32 of the hydrogen generation electrode 30 perpendicular to the third direction D3.

A cross-sectional shape in the cross-section PL (refer to FIG. 2) of the oxygen electrode part 22 and the hydrogen electrode part 32 perpendicular to the third direction D3 may be a triangular shape as illustrated in FIG. 9 in addition to the rectangular shape.

An angle α₁ illustrated in FIG. 9 is an angle formed between a horizontal line B₁ and an inclined surface 60a. The angle α₁ of the inclined surface 60a illustrated in FIG. 9 is not particularly limited as long as the cross-sectional shape is a triangular shape. Additionally, the angles α₁ of two inclined surfaces 60a may be the same as each other or may be different from each other.

Additionally, a cross-sectional shape in the cross-section PL (refer to FIG. 2) of the oxygen electrode part 22 and the hydrogen electrode part 32 perpendicular to the third direction D3 may be a convex shape as illustrated in FIG. 10. A configuration illustrated in FIG. 10 has a convex curved surface 62. In addition to this, the cross-sectional shape may be a semicircular shape or a round shape. A circle and an ellipse are included in the round shape.

Moreover, a cross-sectional shape in the cross-section PL (refer to FIG. 2) of the oxygen electrode part 22 and the hydrogen electrode part 32 perpendicular to the third direction D3 may be a polygonal shape as illustrated in FIG. 11. A configuration illustrated in FIG. 11 is constituted by two inclined surfaces 64a, and a surface 64b parallel to the horizontal lines B₁. An angle α₂ of an inclined surface 64a is an angle formed between the horizontal line B₁ and the inclined surface 64a. In addition, the angles α₂ of the two inclined surfaces 64a may be the same as each other or may be different from each other.

A cross-sectional shape in the cross-section PL (refer to FIG. 2) of the oxygen electrode part 22 and the hydrogen electrode part 32 perpendicular to the third direction D3 may be a concave shape as illustrated in FIG. 12. A configuration illustrated in FIG. 12 has a concave surface 66.

<Planar Configuration of Electrode>

Although the shape of the oxygen electrode part 22 of the oxygen generation electrode 20 and the hydrogen electrode part 32 of the hydrogen generation electrode 30 in the second direction D2 is, for example, an oblong shape, the shape is not limited to this and may be a square shape, or a polygonal shape, such as a triangular shape. As long as the shape of the oxygen electrode part 22 and the hydrogen electrode part 32 in the second direction D2 is a planar shape having a region surrounded by a straight line, the shape is not particularly limited, and may be an oblong shape in which long sides are constituted by broken lines, such as sawtooth waveforms. Additionally, the shape of the oxygen electrode part 22 and the hydrogen electrode part 32 of the hydrogen generation electrode 30 in the second direction D2 may be a planar shape having a region surrounded by a straight line and a curved line. In this case, for example, an oblong shape in which long sides are constituted by curved lines, such as waveforms, may be adopted.

In addition, as for the oxygen electrode part 22 and the hydrogen electrode part 32 from a viewpoint of the arrangement of electrodes, and the ease of manufacture, it is preferable that the oxygen electrode part 22 and the hydrogen electrode part 32 have a congruent shape. However, oxygen electrode parts 22 or hydrogen electrode parts 32 may have a congruent shape. Additionally, the oxygen electrode part 22 and the hydrogen electrode part 32 may have a similar shape.

In addition, in the above-described artificial photosynthesis module an electromotive force required for the decomposition of the water AQ is obtained by the incident light L, using a photocatalyst. However, the invention is not limited to this. For example, instead of obtaining the above-described electromotive force by the incident light L, a configuration in which the electromotive force is supplied from the outside of the artificial photosynthesis module by a power source or the like may be adopted. In addition to this, the electromotive force from the outside may be obtained by, for example, solar battery, wind power, or the like. In the case of a configuration in which the electromotive force is supplied from the outside, the container 12 in which the water AQ is stored, the power source, and the may be integral with each other. However, these are may be disposed to be spaced apart from each other, using wiring lines or the like.

In the above-described artificial photosynthesis module electrode and artificial photosynthesis module, one in which the water AQ is decomposed to generate oxygen and hydrogen as gases has been described as an example. However, the invention is not limited to this, and methane or the like may be generated.

The raw material fluid to be decomposed can be liquids and gases other than the water AQ, and the raw material fluid to be decomposed is not limited to the water AQ. Additionally, in the electrodes for the artificial photosynthesis module electrode, and the artificial photosynthesis module, the first fluid and the second fluid to be generated are not limited to oxygen and hydrogen, and a liquid or gas can be obtained from the raw material fluid by adjusting the configuration of the electrodes. For example, persulfate can be obtained from sulfuric acid. Hydrogen peroxide can be obtained from water, hypochlorite can be obtained from salt, periodate can be obtained from iodate, and tetravalent cerium can be obtained from trivalent cerium.

The invention is basically configured as described above. Although the artificial photosynthesis module electrode and the artificial photosynthesis module of the invention have been described above in detail, it is natural that the invention is not limited to the above-described embodiment, and various improvements or modifications may be made without departing from the scope of the invention.

### EXAMPLES

Hereinafter, the features of the invention will be more specifically described below with reference to examples. Materials, reagents, amounts used, substance amounts, ratios, treatment contents, treatment procedures, and the like that are shown in the following examples can be appropriately changed, unless departing from the spirit of the invention. Therefore, the scope of the invention should not be restrictively interpreted by the specific examples shown below.

In the present example electrodes of Example 1 to Example 7 and Comparative Example 1 to Comparative Example 6 were made, and the electrolysis voltage, the durability, and reverse reaction rate were evaluated.

The configurations of the electrodes of Example 1 to Example 7 and Comparative Example 1 to Comparative Example 6 were configurations in which the configuration illustrated in FIGS. 1 and 2, and the configuration or parallel flat plate illustrated in FIG. 5 were overlappingly configured, and the electrolytic aqueous solution was supplied in the direction J parallel to the first direction D1. In addition, the electrodes were made of platinum.

As for the electrolysis voltage, the voltage was measured by controlling current values to a hydrogen generation electrode and an oxygen generation electrode using a potentiostat such that the conversion efficiency 10% is obtained while supplying the electrolytic aqueous solution.

In addition, the electrolysis voltage is a voltage obtained by subtracting a theoretical electrolysis voltage of water from a total electric potential of an anode and a cathode (the hydrogen generation electrode and the oxygen generation electrode) required for electrolysis of water (electrolytic aqueous solution). It is meant that, as the electrolysis voltage is smaller, the electrolysis efficiency of water is higher. The electric current equivalent to 10% of the conversion efficiency is an electric current of which the current density reaches 8.13 mA/cm².

Hereinafter, the electrolytic solution and the potentiostat used for the evaluation are shown.

Electrolytic solution: 1M H₃BO₃+KOH pH9.5

Potentiostat: HZ-5000 made by HOKUTO DENKO, INC.

As for the durability, current values equivalent to an energy conversion efficiency of 20% were passed through the hydrogen generation electrode and the oxygen generation electrode for 30 minutes while supplying the electrolytic aqueous solution, and increases in voltage value were recorded. This was repeated, and the number of times until an increase in voltage value becomes 30% or more was determined.

In addition, the same components as those for the above-described electrolysis voltage were used as a light source of pseudo solar light, the electrolytic solution, and the potentiostat.

In the column of the durability of the following Table 1, “>50” indicates the increase in voltage value is less than 30% even at 50 times.

As for the reverse reaction rate, the generated hydrogen was recovered, and the amount of recovered hydrogen was determined using gas chromatography. The percentage of the amount of recovered hydrogen was determined with the amount of theoretically obtained hydrogen being 100, and this percentage was used as the reverse reaction rate. The reverse reaction rate means that a smaller value is less reverse reaction, and the smaller value indicates higher efficiency. In the following Table 1, the reverse reaction rate is expressed in percentage.

In the gas chromatography, AGILENT 490 MICRO GC made by GL Sciences, INC. was used.

### Example 1

Example 1 had the configuration illustrated in FIGS. 1 and 2, and each of a hydrogen generation electrode and an oxygen generation electrode was obtained by forming a titanium film formed on a glass substrate in a pattern with the following electrode part dimensions and electrode spacing, using photolithography. Thereafter, a platinum film was formed on a front surface of the titanium film. The hydrogen generation electrode and the oxygen generation electrode are electrodes in which a platinum film was formed on the front surface of the titanium film.

The dimensions of the electrode part were 20 mm×20 μm×100 nm in thickness, and the hydrogen generation electrode and the oxygen generation electrode were inserted into each other. The electrode spacing between the hydrogen generation electrode and the oxygen generation electrode was 10 μm.

### Example 2

Example 2 was the same as Example 1 except that, as compared to Example 1, the electrode spacing between the hydrogen generation electrode and the oxygen generation electrode is 20 μM.

### Example 3

Example 3 was the same as Example 1 except that, as compared to Example 1, the electrode spacing between the hydrogen generation electrode and the oxygen generation electrode is 100 μm.

### Example 4

Example 4 was the same as Example 1 except that, as compared to Example 1, the electrode spacing between the hydrogen generation electrode and the oxygen generation electrode is 200 μm.

### Example 5

Example 5 was the same as Example 1 except that, as compared to Example 1, the electrode spacing between the hydrogen generation electrode and the oxygen generation electrode is 500 μm.

### Example 6

Example 6 was the same as Example 1 except that, as compared to Example 1, the electrode spacing between the hydrogen generation electrode and the oxygen generation electrode is 800 μm.

### Example 7

Example 7 was the same as Example 1 except that, as compared to Example 1, in the configuration illustrated in FIGS. 3 and 4, the hydrogen generation electrode and the oxygen generation electrode are spaced apart from each other and the electrode spacing between the hydrogen generation electrode and the oxygen generation electrode is 200 μm.

### Comparative Example 1

Comparative Example 1 was the same as Example 1 except that, as compared to Example 1, the electrode spacing between the hydrogen generation electrode and the oxygen generation electrode is 2 μM.

### Comparative Example 2

Comparative Example 2 was the same as Example 1 except that, as compared to Example 1, the electrode spacing between the hydrogen generation electrode and the oxygen generation electrode is 3 μm.

### Comparative Example 3

Comparative Example 3 was the same as Example 1 except that, as compared to Example 1, the electrode spacing between the hydrogen generation electrode and the oxygen generation electrode is 5 μm.

### Comparative Example 4

Comparative Example 4 was the same as Example 1 except that, as compared to Example 1, the electrode spacing between the hydrogen generation electrode and the oxygen generation electrode is 1000 μm.

### Comparative Example 5

Comparative Example 5 was the same as Example 1 except that, as compared to Example 1, the electrode configuration is a parallel plate and the electrode spacing between the hydrogen generation electrode and the oxygen generation electrode is 500 μm.

### Comparative Example 6

Comparative Example 6 was the same as Example 1 except that, as compared to Example 1, the electrode configuration is a parallel plate and the electrode spacing between the hydrogen generation electrode and the oxygen generation electrode is 800 μm.

TABLE 1

| | | | | | | Reverse |
|---|---|---|---|---|---|---|
| | Electrode | | | | | Reaction |
| | Spacing | Electrode | Electrode | Electrolysis | Durability | Rate |
| | (μm) | Arrangement | Shape | Voltage (V) | (Times) | (%) |
| Example 1 | 10 | Horizontal | Comb | 2.6 | >50 | 50 |
| Example 2 | 20 | Horizontal | Comb | 2.63 | >50 | 45 |
| Example 3 | 100 | Horizontal | Comb | 2.69 | >50 | 30 |
| Example 4 | 200 | Horizontal | Comb | 2.72 | >50 | 20 |
| Example 5 | 500 | Horizontal | Comb | 3.01 | >50 | 5 |
| Example 6 | 800 | Horizontal | Comb | 3.2 | >50 | 1 |
| Example 7 | 200 | Vertical | Comb | 2.79 | >50 | 20 |
| Comparative | 2 | Horizontal | Comb | 2.53 | 8 | 95 |
| Example 1 | | | | | | |
| Comparative | 3 | Horizontal | Comb | 2.55 | 13 | 93 |
| Example 2 | | | | | | |
| Comparative | 5 | Horizontal | Comb | 2.53 | 15 | 90 |
| Example 3 | | | | | | |
| Comparative | 1000 | Horizontal | Comb | 3.5 | >50 | 0 |
| Example 4 | | | | | | |
| Comparative | 500 | Vertical | Parallel | 4.1 | >50 | 6 |
| Example 5 | | | Flat Plate | | | |
| Comparative | 800 | Vertical | Parallel | 4.1 | >50 | 1 |
| Example 6 | | | Flat Plate | | | |

As shown in Table 1, in Example 1 to Example 7, irrespective of the electrode arrangement, the electrolysis voltage is small, the reverse reaction rate is small, and the efficiency is excellent. Moreover, in Example 1 to Example 7, the durability is also excellent.

On the other hand, in Comparative Example 1 to Comparative Example 6, the electrode spacing is narrow, and in Comparative Example 1 to Comparative Example 3, the reverse reaction rate is high and the efficiency is poor. Additionally, in Comparative Example 1 to Comparative Example 3, the durability is not excellent, either.

In Comparative example 4 the electrode spacing is wide, the electrolysis voltage is high, and the efficiency is poor. In Comparative Example 5 and Comparative Example 6, the electrode configuration is a parallel flat plate, the electrolysis voltage is high, and the efficiency is poor. In addition, in a case where the water decomposition efficiency was measured with the same configurations as those of the above-described Example 1 to Example 7 regarding a combination of an electrode material of BiVO₄ and CIGS, the same tendency was confirmed with respect to the same interelectrode distance and water decomposition efficiency. The water decomposition efficiency was estimated from the amount of generated gas by the gas chromatography.

Moreover, in a case where 0.5 M of NaCl was added to the electrolytic solution (1M H₃BO₃+KOH pH9.5) and the electrolysis voltage, the durability, and the reverse reaction rate were evaluated using the same electrodes as those of the above-described Example 1 to Example 7 even in an environment in which hypochlorous acid was obtained, it was confirmed that the same tendencies as those of the above-described Example 1 to Example 7 were shown regarding the electrode spacing, the electrode arrangement, and the electrode shape. Explanation of references
10: artificial photosynthesis module
12: container
12a: inside
12b: surface
12d, 12e: lateral surface
13: exhaust pipe
14: supply pipe
16: discharge pipe
17: substrate
17a: front surface
20, 20a, 20b: oxygen generation electrode
21: first plane
22: oxygen electrode part
22c, 32c: end part
23, 33: gap
25: first conductive member
26: oxygen electrode base material part
27: first recess
30, 30a, 30b: hydrogen generation electrode
31: second plane
32: hydrogen electrode part
35: second conductive member
36: hydrogen electrode base material part
37: second recess
38: artificial photosynthesis module electrode
39: pair
40: first substrate
42: first conductive layer
44: first photocatalyst layer
44a, 50a, 54a: front surface
46: first co-catalyst
47: co-catalyst particle
50: second substrate
52: second conductive layer
54: second photocatalyst layer
56: second co-catalyst
57: co-catalyst particle
60a, 64a: inclined surface
62: curved surface
64b: surface
66: concave surface
AQ: water
B: horizontal plane
B₁: horizontal line
D1: first direction
D2: second direction
D3: third direction
J: direction
L: light
α₁: angle
α₂: angle
δ: electrode spacing
δ₁: spacing
δ₂: spacing
δ₃: distance
γ: length

What is claimed is:

1. An artificial photosynthesis module electrode comprising:
a first electrode that decomposes a raw material fluid with light to obtain a first fluid;
a first conductive member connected to the first electrode;
a second electrode that decomposes the raw material fluid with the light to obtain a second fluid; and
a second conductive member connected to the second electrode,
wherein the first electrode has a plurality of first electrode parts connected to the first conductive member and disposed with a gap in a first direction on a first plane,
wherein the second electrode has a plurality of second electrode parts connected to the second conductive member and disposed with a gap in the first direction on a second plane parallel to or identical to the first plane,
wherein the first electrode part and the second electrode part are alternately disposed with each other as seen from a second direction perpendicular to the first plane, and
wherein an electrode spacing between the first electrode part and the second electrode part is more than 5 μm and less than 1 mm.

2. An artificial photosynthesis module electrode comprising:
a first electrode that decomposes a raw material fluid with light to obtain a first fluid;
a first electrode base material part connected to the first electrode;
a second electrode that decomposes the raw material fluid with the light to obtain a second fluid; and
a second electrode base material part connected to the second electrode,
wherein the first electrode has a plurality of first electrode parts connected to the first electrode base material part and disposed with a gap in a first direction on a first plane, and the first electrode includes a first recess formed by the first electrode parts and the first electrode base material part,
wherein the second electrode has a plurality of second electrode parts connected to the second electrode base material part and disposed with a gap in the first direction on a second plane parallel to or identical to the first plane, and the second electrode includes a second recess formed by the second electrode parts and the second electrode base material part,
wherein the first electrode part and the second electrode part are alternately disposed with each other as seen from a second direction perpendicular to the first plane, the second electrode part enters the first recess, and the first electrode part enters the second recess,
wherein an electrode spacing between the first electrode part and the second electrode part is more than 5 μm and less than 1 mm, and
wherein the electrode spacing is an average value of a spacing between the first electrode part and the second electrode base material part, a spacing between the second electrode part and the first electrode base material part, and a distance between the first electrode part and the second electrode part that are adjacent to each other.

3. The artificial photosynthesis module electrode according to claim 1,
wherein the electrode spacing is more than 5 μm and 500 μm or less.

4. The artificial photosynthesis module electrode according to claim 2,
wherein the electrode spacing is more than 5 μm and 500 μm or less.

5. The artificial photosynthesis module electrode according to claim 1,
wherein the first electrode part or the second electrode part, which is disposed on an incidence side of the light, out of the first electrode part and the second electrode part, transmits the light.

6. The artificial photosynthesis module electrode according to claim 2,
wherein the first electrode part or the second electrode part, which is disposed on an incidence side of the light, out of the first electrode part and the second electrode part, transmits the light.

7. The artificial photosynthesis module electrode according to claim 1,
wherein the first electrode includes a first recess formed by the first electrode parts and the first conductive member, or the second electrode includes a second recess formed by the second electrode parts and the second conductive member, and
wherein the electrode part on the other side enters the first recess or the second recess as seen from the second direction.

8. The artificial photosynthesis module electrode according to claim 1,
wherein the first electrode includes a first recess formed by the first electrode parts and the first conductive member,
wherein the second electrode includes a second recess formed by the second electrode parts and the second conductive member, and
wherein as seen from a second direction perpendicular to the first plane and the second plane, the second electrode part enters the first recess and the first electrode part enters the second recess.

9. The artificial photosynthesis module electrode according to claim 1,
wherein the first electrode includes a first recess formed by the first electrode parts and the first conductive member,
wherein the second electrode includes a second recess formed by the second electrode parts and the second conductive member,
wherein as seen from the second direction, the second electrode part enters the first recess and the first electrode part enters the second recess, and
wherein the electrode spacing is an average value of a spacing between the first electrode part and the second conductive member, a spacing between the second electrode part and the first conductive member, and a distance between the first electrode part and the second electrode part that are adjacent to each other.

10. The artificial photosynthesis module electrode according to claim 1,
wherein when a direction perpendicular to both the first direction and the second direction is defined as a third direction, cross-sections of the first electrode part of the first electrode and the second electrode part of the second electrode perpendicular to the third direction have a rectangular shape, a triangular shape, a convex type, a semicircular shape, or a round shape.

11. The artificial photosynthesis module electrode according to claim 2,
wherein when a direction perpendicular to both the first direction and the second direction is defined as a third direction, cross-sections of the first electrode part of the first electrode and the second electrode part of the second electrode perpendicular to the third direction have a rectangular shape, a triangular shape, a convex type, a semicircular shape, or a round shape.

12. The artificial photosynthesis module electrode according to claim 1,
wherein the first electrode has a first substrate, a first conductive layer provided on the first substrate, a first photocatalyst layer provided on the first conductive layer, and a first co-catalyst that is carried and supported on at least a portion of the first photocatalyst layer, and
wherein the second electrode has a second substrate, a second conductive layer provided on the second substrate, a second photocatalyst layer provided on the second conductive layer, and a second co-catalyst that is carried and supported on at least a portion of the second photocatalyst layer.

13. The artificial photosynthesis module electrode according to claim 2,
wherein the first electrode has a first substrate, a first conductive layer provided on the first substrate, a first photocatalyst layer provided on the first conductive layer, and a first co-catalyst that is carried and supported on at least a portion of the first photocatalyst layer, and
wherein the second electrode has a second substrate, a second conductive layer provided on the second substrate, a second photocatalyst layer provided on the second conductive layer, and a second co-catalyst that is carried and supported on at least a portion of the second photocatalyst layer.

14. The artificial photosynthesis module electrode according to claim 1,
wherein at least one of the first electrode or the second electrode has a pn junction.

15. The artificial photosynthesis module electrode according to claim 2,
wherein at least one of the first electrode or the second electrode has a pn junction.

16. The artificial photosynthesis module electrode according to claim 1,
wherein the first fluid is a gas or a liquid, and the second fluid is a gas or a liquid.

17. The artificial photosynthesis module electrode according to claim 2,
wherein the first fluid is a gas or a liquid, and the second fluid is a gas or a liquid.

18. An artificial photosynthesis module comprising:
the artificial photosynthesis module electrode according to claim 1.

19. An artificial photosynthesis module comprising:
the artificial photosynthesis module electrode according to claim 2.
